(19) United States
(12) Patent Application Publication
(10) Pub. No.: US 2026/0296286 A1
(43) Pub. Date: Oct. 1, 2026

(54) DISTRIBUTION AND SUPPLY JOINT

(71) Applicant: TOYOTA BOSHOKU KABUSHIKI KAISHA, Aichi (JP)

(72) Inventor: Kai MITSUYA, Kamakura-shi (JP)

(73) Assignee: TOYOTA BOSHOKU KABUSHIKI KAISHA, Aichi (JP)

(21) Appl. No.: 19/575,004

(22) Filed: Mar. 23, 2026

(30) Foreign Application Priority Data
Mar. 27, 2025 (JP) 2025-054003

(51) Int. Cl. B60N 2/90; B60R 16/08

(52) U.S. Cl. CPC B60N 2/90; B60R 16/08

(57) ABSTRACT

A distribution and supply joint for distributing and supplying a fluid includes a joint body including at least a first inlet port, a second inlet port, a first outlet port, a second outlet port, and a third outlet port. The joint body includes therein a distribution flow path allowing the first inlet port to communicate with the first outlet port and the second outlet port, and a tunnel section provided in a portion of a flow path extending from the second inlet port to the third outlet port.

### CROSS-REFERENCE TO RELATED APPLICATIONS

This application claims the benefit of priority based on Japanese patent application No. 2025-054003 filed on Mar. 27, 2025, with the Japan Patent Office, and the entire disclosure of Japanese patent application No. 2025-054003 is incorporated herein by reference.

### BACKGROUND

The present disclosure relates to a distribution and supply joint configured to distribute and supply a fluid to fluid bags provided in a vehicle seat.

For example, in the invention described in Japanese Patent No. 7065992, a plurality of tubes are connected to a fluid switching module via a single joint.

### SUMMARY

When a plurality of tubes are connected, the routing of the tubes becomes complex, and there is a high likelihood that the difficulties in routing the tubes and designing methods for securing the tubes will increase, and that the production difficulty will also increase. The present disclosure provides an example of a distribution and supply joint in consideration of this point.

A distribution and supply joint for distributing and supplying a fluid to air bladders provided in a vehicle seat preferably includes at least one of the following constituent elements.

The constituent elements include following. That is, a joint body includes at least a first inlet port, a second inlet port, a first outlet port, a second outlet port, and a third outlet port. The joint body includes therein: a distribution flow path allowing the first inlet port to communicate with the first outlet port and the second outlet port, the distribution flow path extending in a first direction and being configured to distribute a fluid flowing in from the first inlet port to the first outlet port and the second outlet port; and a tunnel section provided in a portion of a flow path extending from the second inlet port to the third outlet port, the tunnel section extending in a second direction skew to the first direction.

The use of the distribution and supply joint may simplify arrangement and routing (i.e., routing structure) of tubes. Ultimately, it is possible to suppress an increase in difficulty of designing methods for securing the tubes and the like and an increase in production difficulty.

The distribution and supply joint may have, for example, following configurations.

That is, it is preferable that an inflow direction of the fluid of the first inlet port, an inflow direction of the fluid of the second inlet port, an outflow direction of the fluid of the first outlet port, an outflow direction of the fluid of the second outlet port, and an outflow direction of the fluid of the third outlet port are parallel to each other.

It is also preferable that the first outlet port, the second outlet port, and the third outlet port are arranged in series in a third direction, and that the first outlet port and the second outlet port are arranged at positions symmetric with respect to a middle of a portion of the joint body extending parallel to the third direction.

When the distribution flow path is defined as a first distribution flow path and a direction that intersects with the first direction and the second direction is defined as a fourth direction, it is preferable that the joint body is provided with a fourth outlet port, the joint body includes therein a second distribution flow path that is in communication with the second inlet port via the tunnel section, the second distribution flow path extending in a direction parallel to the first direction, the second distribution flow path being configured to distribute and supply the fluid flowing in from the second inlet port to the third outlet port and the fourth outlet port, and that the tunnel section is offset in the fourth direction relative to the first distribution flow path.

It is also preferable that a deflector configured to deflect a flow direction of the fluid flowing out of the tunnel section is provided at an outlet of the tunnel section.

### BRIEF DESCRIPTION OF THE DRAWINGS

Some embodiments of the present disclosure will be described hereinafter by way of example with reference to the accompanying drawings, in which;

FIG. 1 is a diagram showing a vehicle seat in a first embodiment;

FIG. 2 is a diagram showing the vehicle seat in the first embodiment;

FIG. 3 is a diagram showing a distribution and supply joint in the first embodiment;

FIG. 4 is an exploded view of the distribution and supply joint in the first embodiment;

FIG. 5 is a diagram showing a joint body in the first embodiment;

FIG. 6 is a diagram showing the joint body in the first embodiment;

FIG. 7 is a diagram showing the joint body in the first embodiment;

FIG. 8 is a diagram showing the joint body in the first embodiment;

FIG. 9 is a diagram showing the joint body in the first embodiment;

FIG. 10 is a diagram showing the joint body in the first embodiment; and

FIG. 11 is a diagram showing the joint body in the first embodiment.

### DETAILED DESCRIPTION OF EXEMPLARY EMBODIMENTS

The following embodiments of the invention are examples of embodiments that belong to the technical scope of the present disclosure. In other words, matters specifying the invention recited in the claims are not limited to the specific configurations or structures shown in the following embodiments.

The present embodiment is an example in which a distribution and supply joint according to the present disclosure is applied to a seat to be mounted in a vehicle such as an automobile (hereinafter referred to as a "vehicle seat"). Arrows indicating directions in the drawings are provided to facilitate understanding of the relationships among the drawings and the shapes and the like of the members or portions.

Therefore, the distribution and supply joint is not limited to the directions indicated in the drawings. The directions shown in the drawings indicate directions in a state where a vehicle seat in the present embodiment is assembled to a vehicle.

With respect to the members or portions at least described with reference numerals, at least one of them is provided unless otherwise specified by terms such as "only one". In other words, unless otherwise specified by terms such as "only one", two or more of the members may be provided.

### First Embodiment

### 1. Overview of Vehicle Seat

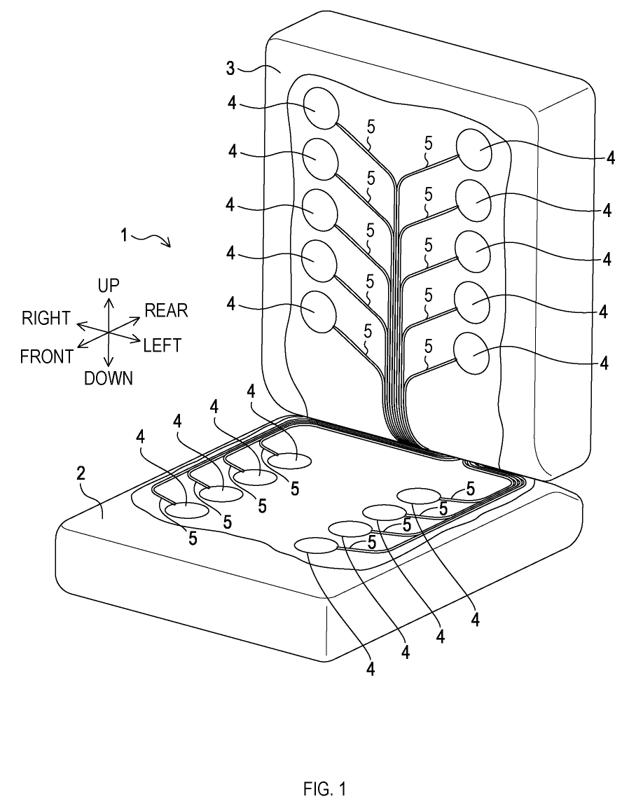

A vehicle seat 1 includes at least a seat cushion 2, a seatback 3, and the like as shown in FIG. 1. The seat cushion 2 is a portion that supports the occupant's buttocks. The seatback 3 is a portion that supports the occupant's back.

At least one of the seat cushion 2 or the seatback 3 (in the present embodiment, both) includes a plurality of air bladders 4 embedded therein. The air bladders 4 expand and contract in response to inflow and outflow of a compressible fluid such as air. Each air bladder 4 is supplied with compressed air via a tube 5.

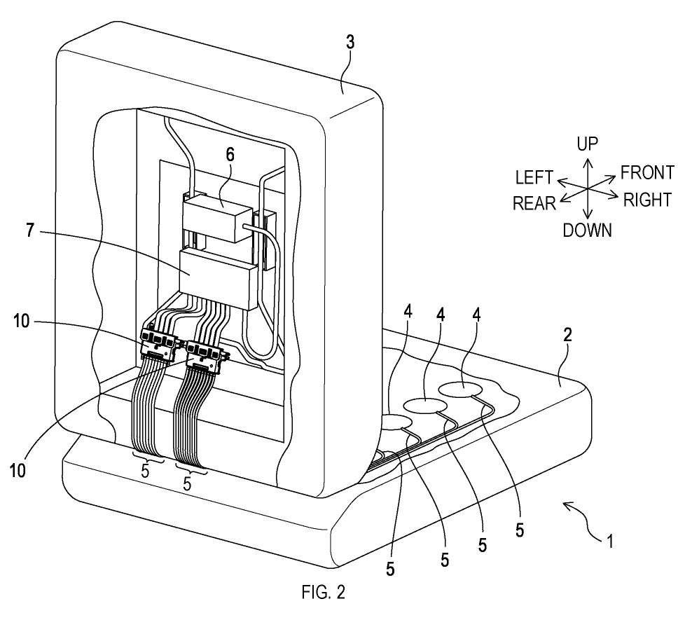

The vehicle seat 1 in the present embodiment includes, as shown in FIG. 2, an air pump 6, a valve unit 7, a distribution and supply joint 10, and the like arranged on a rear-surface side of the seatback 3. The air pump 6 generates compressed air.

The valve unit 7 is a control valve composed of one or more valves that control the flow of the compressed air discharged from the air pump 6. Then, the compressed air supplied from the valve unit 7 is distributed to a plurality of tubes 5 via one or more distribution and supply joints 10.

### 2. Configuration of Distribution and Supply Joint

### 2.1 Overview of Configuration

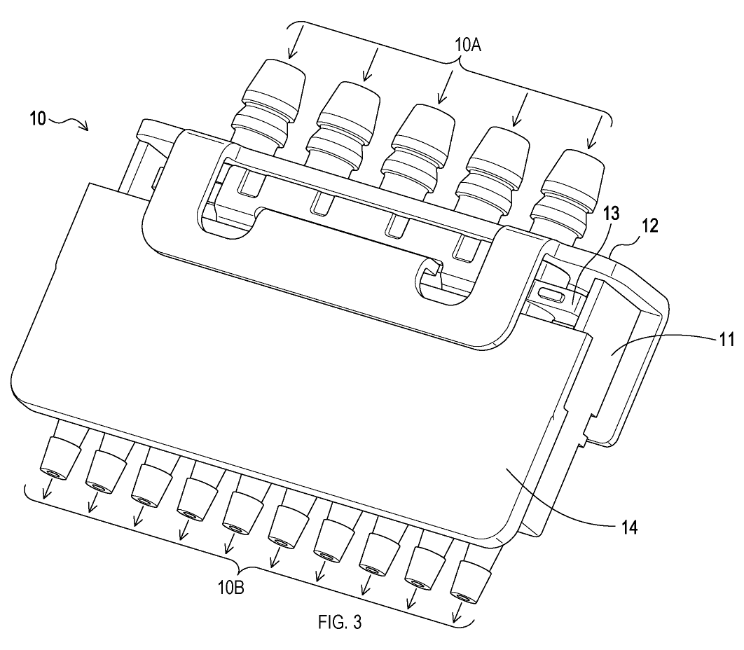

The distribution and supply joint 10 is configured to distribute and supply the compressed air to the plurality of air bladders 4. For this reason, the distribution and supply joint 10 includes, as shown in FIG. 3, connection ports 10A connected to the outflow side of the valve unit 7, and connection ports 10B respectively connected to the air bladders 4.

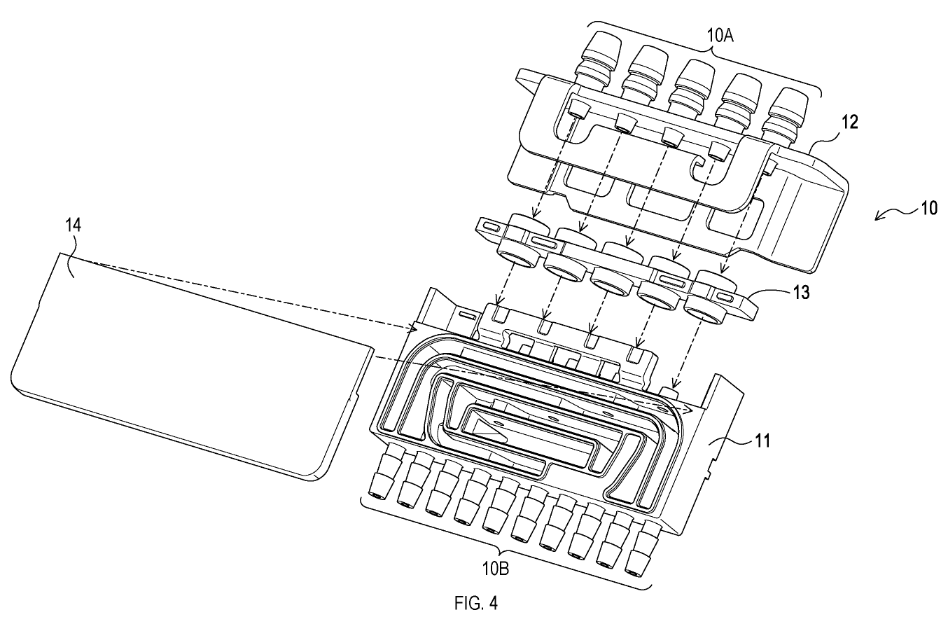

Specifically, the distribution and supply joint 10 includes, as shown in FIG. 4, at least a joint body 11, an inflow-side cover 12, a gasket 13, a body cover 14, and the like. The inflow-side cover 12 is a member that is provided with the connection ports 10A.

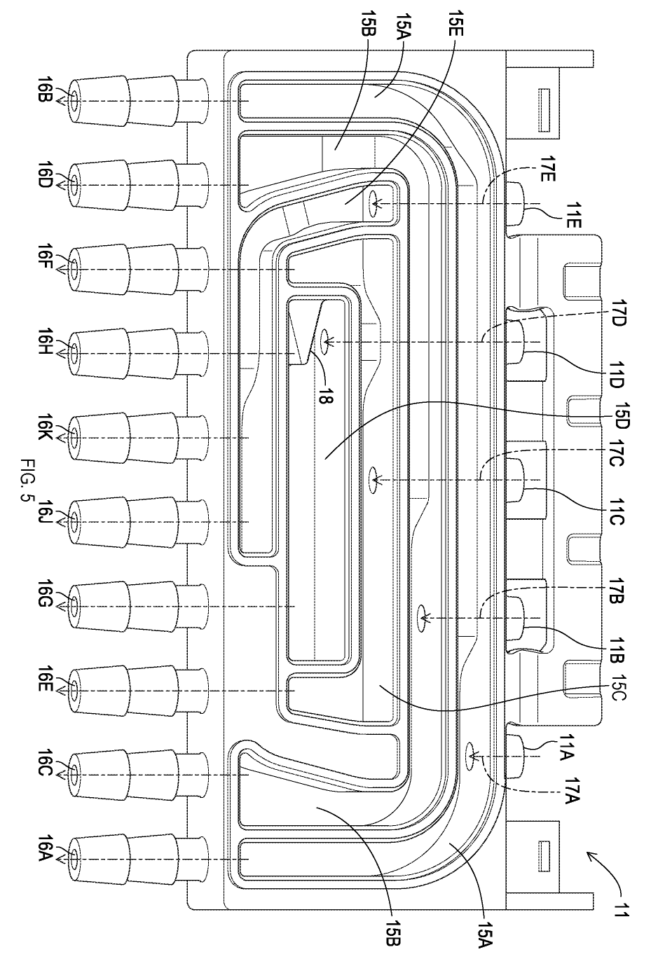

The inflow-side cover 12 is connected, via the gasket 13, to a plurality of inlet ports 11A to 11E (see FIG. 5) formed in the joint body 11. The gasket 13 is a sealing member that maintains airtightness between the connection ports 10A and the inlet ports 11A to 11E.

The body cover 14 is a lid for closing openings of a plurality of distribution flow paths 15A to 15E formed in the joint body 11 (see FIG. 5). The distribution flow paths 15A to 15E are channel-shaped recesses with openings on one side of the block-shaped joint body 11.

### 2.2 Detailed Configuration of Joint Body

The joint body 11 includes, as shown in FIG. 5, the plurality of inlet ports 11A to 11E, the plurality of distribution flow paths 15A to 15E, and a plurality of outlet ports 16A to 16K. In the present embodiment, the number of distribution flow paths is the same as the number of inlet ports, and the number of outlet ports is greater than the number of inlet ports.

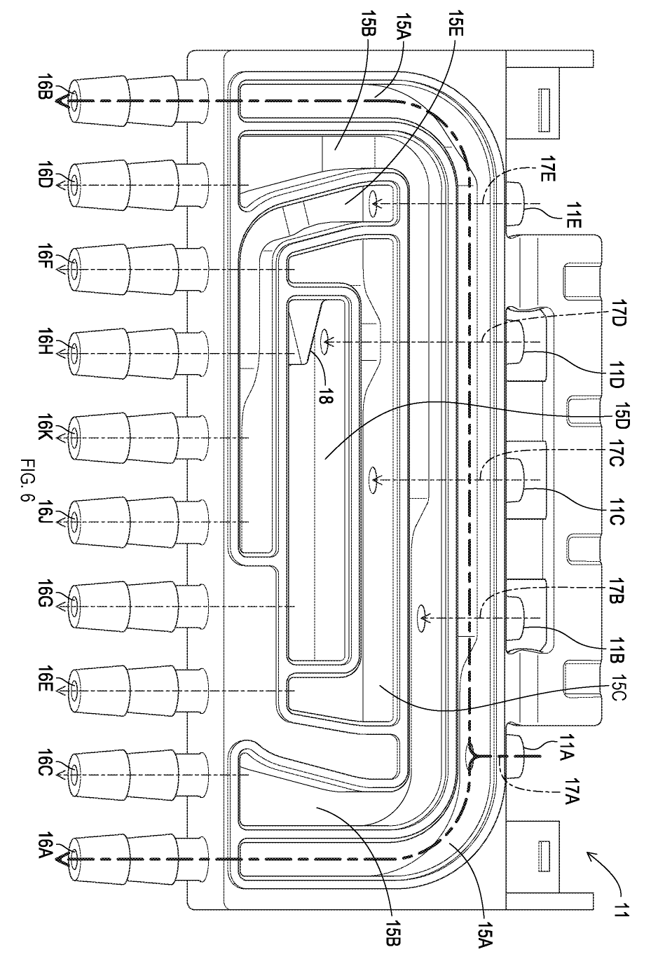

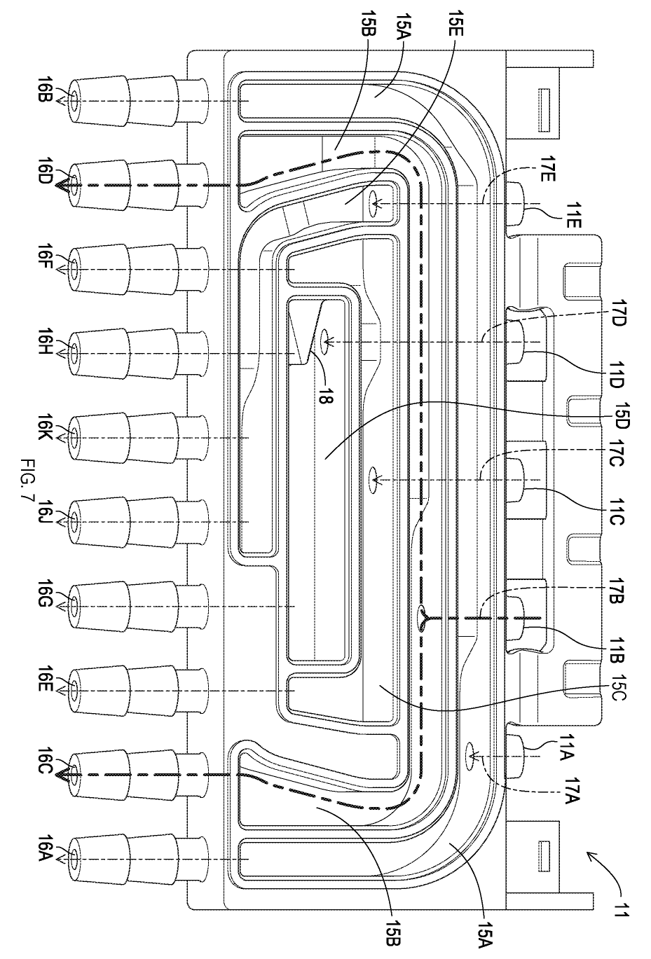

Specifically, the compressed air that flows in from the inlet port 11A is distributed to the outlet ports 16A and 16B via the distribution flow path 15A (see FIG. 6). The compressed air that flows in from the inlet port 11B is distributed to the outlet ports 16C and 16D via the distribution flow path 15B (see FIG. 7).

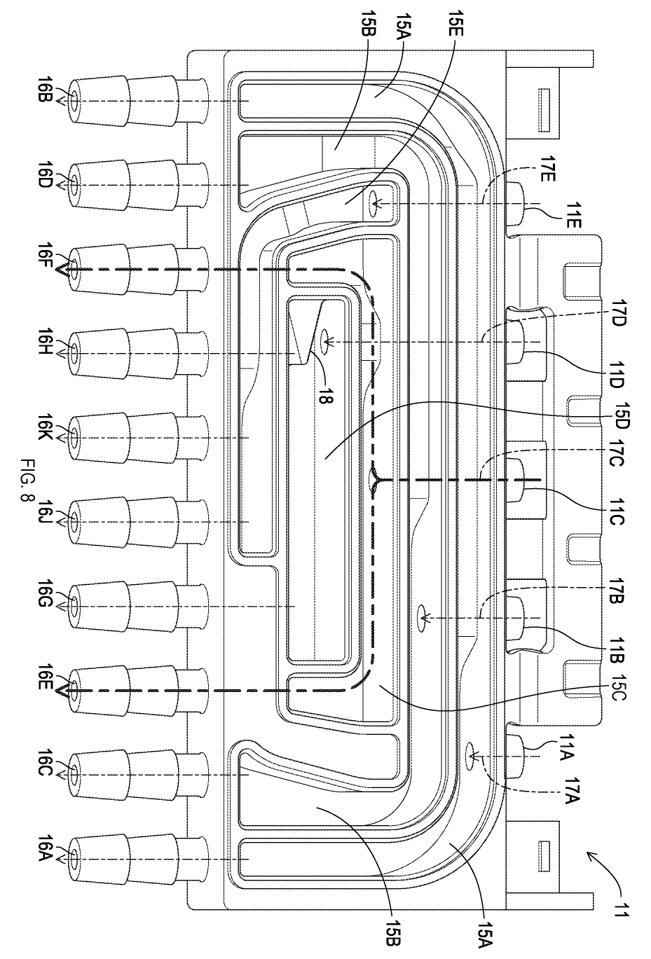

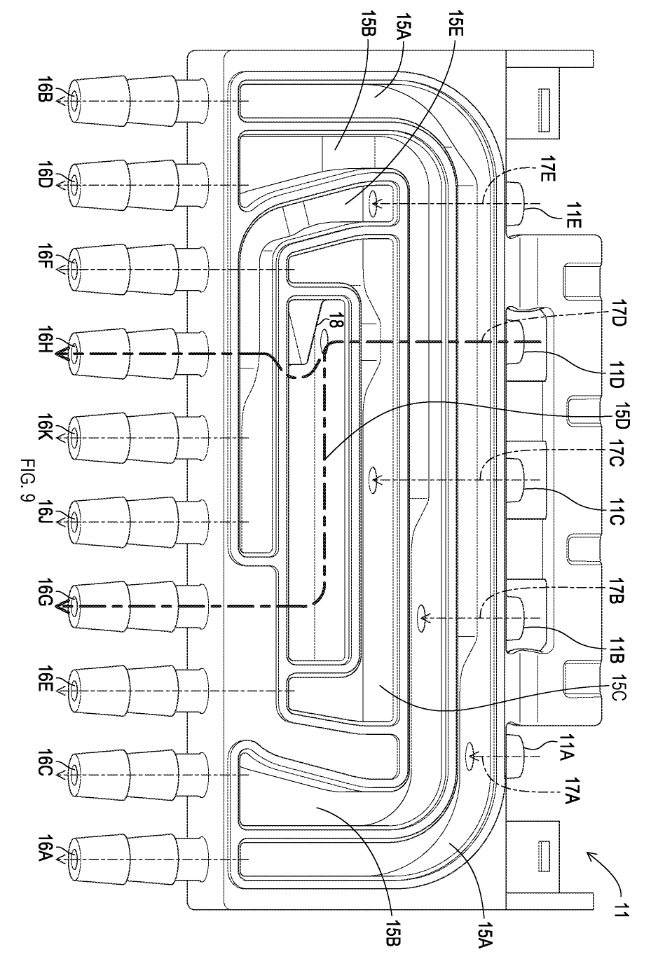

The compressed air that flows in from the inlet port 11C is distributed and supplied to the outlet ports 16E and 16F via the distribution flow path 15C (see FIG. 8). The compressed air that flows in from the inlet port 11D is distributed and supplied to the outlet ports 16G and 16H via the distribution flow path 15D (see FIG. 9).

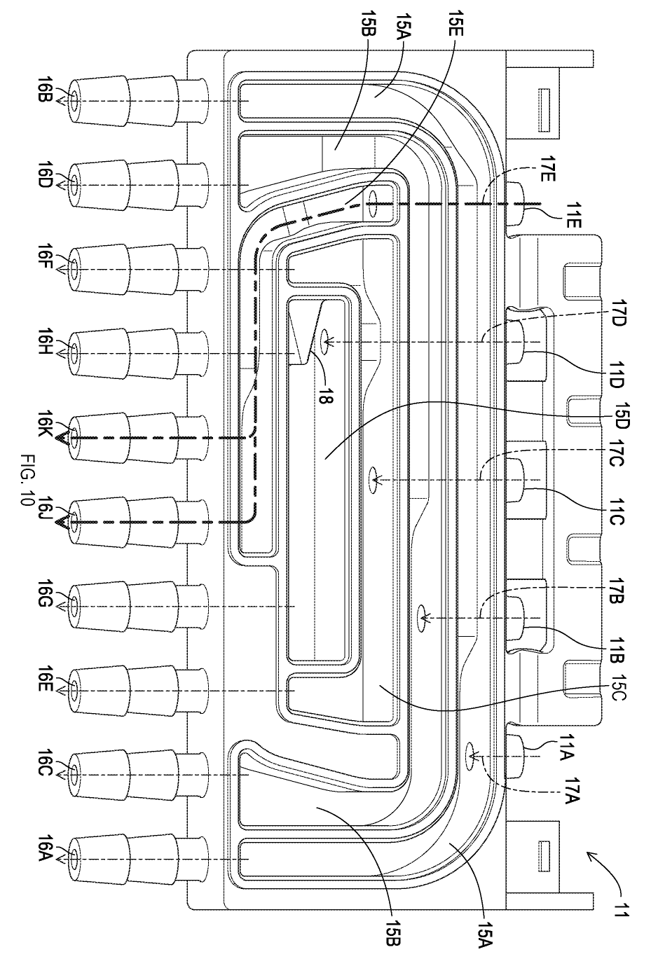

The compressed air that flows in from the inlet port 11E is distributed and supplied to the outlet ports 16J and 16K via the distribution flow path 15E (see FIG. 10). Thus, the compressed air that flows into one distribution flow path from one specific inlet port is distributed to two outlet ports (hereinafter referred to as "pairing two outlet ports").

Thus, the distribution flow paths 15A to 15E each include a distribution section that extends in a first direction (in this embodiment, a left-right direction in FIG. 5) and that distributes the compressed air to the pairing two outlet ports. Hereinafter, unless otherwise specified, the term “distribution flow paths 15A to 15E” refers to the respective distribution sections of the distribution flow paths 15A to 15E.

In the joint body 11 of the present embodiment, air inflow directions of the inlet ports 11A to 11E are parallel to air outflow directions of the outlet ports 16A to 16K (see FIG. 3).

Thus, the first direction in the present embodiment is aligned with a direction that is perpendicular to the air inflow directions of the inlet ports 11A to 11E. Hereinafter, the term "direction that is perpendicular to the air inflow directions" is also referred to as a "width direction" (in the present embodiment, also referred to as the left-right direction in FIGS. 5-10).

The distribution flow paths 15A to 15E respectively correspond to, and are in communication with, the inlet ports 11A to 11E via the tunnel sections 17A to 17E. The tunnel sections 17A to 17E extend in the air inflow directions of the inlet ports 11A to 11E and are in communication with corresponding distribution flow paths 15A to 15E.

Specifically, the inlet port 11A and the distribution flow path 15A are in communication with each other via the tunnel section 17A (see FIG. 6). The inlet port 11B and the distribution flow path 15B are in communication with each other via the tunnel section 17B (see FIG. 7).

The inlet port 11C and the distribution flow path 15C are in communication with each other via the tunnel section 17C (see FIG. 8). The inlet port 11D and the distribution flow path 15D are in communication with each other via the tunnel section 17D (see FIG. 9). The inlet port 11E and the distribution flow path 15E are in communication with each other via the tunnel section 17E (see FIG. 10).

For example, in the present embodiment, the following configuration is established when the inlet port 11A is defined as a first inlet port, the inlet port 11D is defined as a second inlet port, the distribution flow path 15A is defined as a first distribution flow path, the distribution flow path 15D is defined as a second distribution flow path, the outlet port 16A is defined as a first outlet port, the outlet port 16B is defined as a second outlet port, the outlet port 16G is defined as a third outlet port, and the outlet port 16H is defined as a fourth outlet port.

That is, the first distribution flow path 15A, which connects the first inlet port 11A, the first outlet port 16A, and the second outlet port 16B, extends in the first direction (in the present embodiment, the width direction) and distributes and supplies the compressed air that flows in from the first inlet port 11A to the first outlet port 16A and the second outlet port 16B.

The tunnel section 17D, which is provided in a portion of the flow path extending from the second inlet port 11D to the third outlet port 16G, extends in a second direction that is skew to the first direction. The tunnel section 17D is in communication with the second distribution flow path 15D.

Specifically, when a direction that intersects with the first direction and the second direction is defined as a fourth direction, the tunnel section 17D is offset in the fourth direction (in the present embodiment, a thickness direction of the joint body 11) with respect to the first distribution flow path 15A.

The second direction in the present embodiment is perpendicular to the first direction (in the present embodiment, the width direction), and thus, coincides with the air inflow direction. Accordingly, the tunnel section 17D extends in a direction parallel to the air inflow direction of the second inlet port 11D at a position offset in the thickness direction relative to the first distribution flow path 15A.

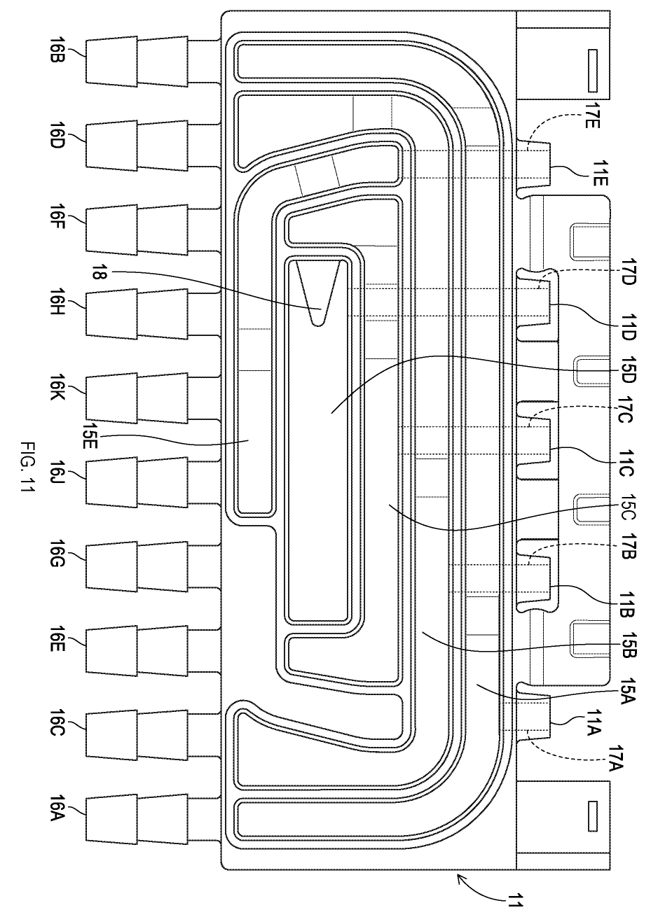

Furthermore, in the present embodiment, as shown in FIG. 11, a deflector 18 is provided at an outlet of the tunnel section 17D. The deflector 18 is a baffle plate that deflects the flow direction of the compressed air flowing out from the tunnel section 17D.

As shown in FIG. 5, the inlet ports 11A to 11E are arranged in series in a third direction (in the present embodiment, the width direction). Similarly, the outlet ports 16A to 16K are also arranged in series in the third direction.

When the "specific inlet port" is defined as the first inlet port, and one of the "pairing two outlet ports" is defined as the first outlet port and the other is defined as the second outlet port, the first outlet port and the second outlet port are arranged at positions symmetric with respect to the middle of a portion of the joint body 11 extending parallel to the third direction.

Specifically, the outlet port 16A and the outlet port 16B are arranged at symmetric positions. The outlet port 16C and the outlet port 16D are arranged at symmetric positions. The outlet port 16E and the outlet port 16F are arranged at symmetric positions. The outlet port 16G and the outlet port 16H are arranged at symmetric positions. The outlet port 16J and the outlet 16K are arranged at symmetric positions.

In the present embodiment, when the inlet port 11B, the inlet port 11C, or the inlet port 11E is defined as the second inlet port, the aforementioned configuration can also be established. Specifically, the tunnel sections 17B to 17E extend in a direction parallel to the air inflow direction at positions offset in the thickness direction relative to the distribution flow path 15A.

For example, when the inlet port 11B is defined as the first inlet port, and any one of the inlet ports 11C to 11E is defined as the second inlet port, the aforementioned configuration is also established. Specifically, each of the tunnel sections 17C to 17E extends in a direction parallel to the air inflow direction at positions offset in the thickness direction relative to the distribution flow path 15B.

### 3. Features of the Distribution and Supply Joint in the Present Embodiment

As shown in FIG. 2, the use of the distribution and supply joint 10 in the present embodiment may simplify the arrangement and routing (i.e., the routing structure) of the tubes 5. Ultimately, it is possible to suppress an increase in difficulty of designing methods for securing the tubes 5 and an increase in production difficulty.

### Other Embodiments

In the above embodiment, the first outlet port and the second outlet port are arranged at positions symmetric with respect to the middle of the portion of the joint body 11 extending parallel to the third direction. However, the present disclosure is not limited to this configuration. That is, the present disclosure may include a configuration in which the first outlet port and the second outlet port are arranged adjacent to each other.

In the above embodiment, the deflector 18 is provided at the outlet of the tunnel section 17D. However, the present disclosure is not limited to this configuration. That is, the present disclosure may include a configuration in which the deflector 18 is omitted.

The aforementioned embodiment is an example in which the distribution and supply joint of the present disclosure is applied to a distribution and supply joint configured for distributing and supplying compressed air. However, the present disclosure is not limited to this configuration. That is, the present disclosure may be applied to a distribution and supply joint for distributing and supplying an incompressible fluid, such as water.

In the above embodiment, the inlet ports 11A to 11E are arranged in series, and the outlet ports 16A to 16K are also arranged in series. However, the present disclosure is not limited to this configuration.

In the aforementioned embodiment, the air inflow directions of the inlet ports 11A to 11E and the air outflow directions of the outlet ports 16A to 16K are parallel to each other, and the first direction and the third direction coincide. However, the present disclosure is not limited to this configuration.

In the aforementioned embodiment, the vehicle seat of the present disclosure is applied to an automobile. However, the application of the invention disclosed herein is not limited thereto. That is, the present disclosure can also be applied to seats used in other vehicles, such as railroad vehicles, ships/boats, and aircraft, and to stationary seats used in theaters, homes, and the like.

Furthermore, the present disclosure is not limited to the aforementioned embodiments, provided that any modification or variation remains consistent with the gist of the disclosure described in the aforementioned embodiments. Therefore, a configuration may be adopted in which any two or more of the aforementioned embodiments are combined. In addition, a configuration may be adopted in which any of the elements illustrated in the drawings or described with reference numerals in the aforementioned embodiments is omitted.

What is claimed is:

1. A distribution and supply joint for distributing and supplying a fluid to air bladders provided in a vehicle seat, the distribution and supply joint comprising:
a joint body including at least a first inlet port, a second inlet port, a first outlet port, a second outlet port, and a third outlet port,
wherein the joint body includes therein
a distribution flow path allowing the first inlet port to communicate with the first outlet port and the second outlet port, the distribution flow path extending in a first direction, the distribution flow path being configured to distribute and supply the fluid flowing in from the first inlet port to the first outlet port and the second outlet port, and
a tunnel section provided in a portion of a flow path extending from the second inlet port to the third outlet port, the tunnel section extending in a second direction skew to the first direction.

2. The distribution and supply joint according to claim 1,
wherein an inflow direction of the fluid of the first inlet port, an inflow direction of the fluid of the second inlet port, an outflow direction of the fluid of the first outlet port, an outflow direction of the fluid of the second outlet port, and an outflow direction of the fluid of the third outlet port are parallel to each other.

3. The distribution and supply joint according to claim 2,
wherein the first outlet port, the second outlet port, and the third outlet port are arranged in series in a third direction, and
the first outlet port and the second outlet port are arranged at positions symmetric with respect to a middle of a portion of the joint body extending parallel to the third direction.

4. The distribution and supply joint according to claim 1,
wherein the distribution flow path is defined as a first distribution flow path,
the joint body is provided with a fourth outlet port,
the joint body includes therein a second distribution flow path that is in communication with the second inlet port via the tunnel section, the second distribution flow path extending in a direction parallel to the first direction, the second distribution flow path being configured to distribute and supply the fluid flowing in from the second inlet port to the third outlet port and the fourth outlet port, and
the tunnel section is offset in a fourth direction relative to the first distribution flow path, the fourth direction intersecting with the first direction and the second direction.

5. The distribution and supply joint according to claim 4, further comprising a deflector provided at an outlet of the tunnel section and configured to deflect a flow direction of the fluid flowing out of the tunnel section.

6. The distribution and supply joint according to claim 2,
wherein the distribution flow path is defined as a first distribution flow path,
the joint body is provided with a fourth outlet port,
the joint body includes therein a second distribution flow path that is in communication with the second inlet port via the tunnel section, the second distribution flow path extending in a direction parallel to the first direction, the second distribution flow path being configured to distribute and supply the fluid flowing in from the second inlet port to the third outlet port and the fourth outlet port, and
the tunnel section is offset in a fourth direction relative to the first distribution flow path, the fourth direction intersecting with the first direction and the second direction.

7. The distribution and supply joint according to claim 6, further comprising a deflector provided at an outlet of the tunnel section and configured to deflect a flow direction of the fluid flowing out of the tunnel section.
